(19) United States
(12) Patent Application Publication
(10) Pub. No.: US 2026/0300538 A1
(43) Pub. Date: Oct. 1, 2026

(54) SYSTEM AND METHOD FOR HANDLING PRIVACY-PRESERVING CONFIDENTIAL SET INTERSECTION

(71) Applicant: Hong Kong Applied Science and Technology Research Institute Company Limited, Hong Kong (HK)

(72) Inventors: Jitao OU, Hong Kong (HK); Yue LIU, Hong Kong (HK); Wai Kai Arvin TANG, Hong Kong (HK)

(21) Appl. No.: 19/095,007

(22) Filed: Mar. 30, 2025

(51) Int. Cl. G06F 21/62

(52) U.S. Cl. CPC G06F 21/6245

(57) ABSTRACT

A system includes a first-party processing module, a second-party processing module, and a third-party processing module. The first-party and second-party processing modules respectively include encryption modules and encrypted label transmission modules for encrypting and hashing local identifier sets into hashed ID lists using an agreed encryption technique, and for transmitting encrypted identifiers or partial encrypted labels. The third-party processing module includes a computation module configured to receive encrypted identifiers or partial labels from both parties and compute a matching result indicating whether entries correspond to a match, thereby generating a matching table containing real and dummy matches. A subset regrouping module regroups the matching table into subsets selectively distributed to each party to prevent full intersection reconstruction. A result delivery module outputs a pseudo set intersection alignment result, based on the distributed subsets, to the first-party and second-party processing modules for use in privacy-preserving computations.

### TECHNICAL FIELD

The present invention relates to the field of privacy-preserving data handling, particularly in enhancing label protection for scenarios involving the determination of the intersection of two label sets in vertical federated learning.

### BACKGROUND

Federated learning has emerged as a promising solution to leverage more data while maintaining data privacy. It enables collaborative machine learning model training across distributed devices or servers without sharing sensitive data. Typically, in vertical federated learning, identity matching plays a crucial role in harnessing shared information across sources while maintaining data privacy and security.

Two separate parties each hold a set of unique labels and need to find their intersection, as seen in scenarios like identity matching in vertical federated learning. When two or more parties find the intersection of their unique label sets, there are concerns on label protection that need to be addressed. For example, whether the overlapping labels will be revealed by any one of the parties, or whether insiders can reconstruct hashes of labels.

Therefore, an improved confidential set intersection method is needed to strengthen privacy protection while mitigating the risk of unauthorized inference or reconstruction of hashed identifiers during identity matching.

### SUMMARY OF INVENTION

In accordance with a first aspect of the present invention, a system for handling privacy-preserving confidential set intersection is provided. The system includes a first-party processing module, a second-party processing module, and a third-party processing module. The first-party processing module includes a first encryption module and a first encrypted label transmission module. The second-party processing module includes a second encryption module and a second encrypted label transmission module. The first encryption module is configured to encrypt and hash a first set of identifiers into a first hashed ID list using an encryption technique agreed with the second-party processing module. The first encrypted label transmission module is configured to transmit one or more encrypted identifiers or partial encrypted labels derived from the first hashed ID list. The second encryption module is configured to encrypt and hash a second set of identifiers into a second hashed ID list using the encryption technique. The second encrypted label transmission module is configured to transmit one or more encrypted identifiers or partial encrypted labels derived from the second hashed ID list. The third-party processing module includes a computation module, a subset regrouping module, and a result delivery module. The computation module is configured to receive the encrypted identifiers or the partial encrypted labels from both the first encrypted label transmission module of the first-party processing module and the second encrypted label transmission module of the second-party processing module. The computation module is configured to compute a matching result indicating whether the encrypted identifiers from the first and second hashed ID lists correspond to a match, thereby generating a matching table comprising real and dummy matches. The subset regrouping module is configured to regroup the matching table into subsets, which are selectively distributed to the first-party processing module and the second-party processing module, in order to prevent reconstruction of full intersection. The result delivery module is configured to output a pseudo set intersection alignment result, based on the subsets to be distributed, to the first-party processing module and the second-party processing module for use in subsequent privacy-preserving computations.

In accordance with a second aspect of the present invention, a method for handling privacy-preserving confidential set intersection is provided. The method includes steps as follows: encrypting and hashing, by a first encryption module of a first-party processing module, a first set of identifiers into a first hashed ID list using an encryption technique agreed upon with a second-party processing module; encrypting and hashing, by a second encryption module of the second-party processing module, a second set of identifiers into a second hashed ID list using the encryption technique; transmitting, by a first encrypted label transmission module of the first-party processing module, one or more encrypted identifiers or partial encrypted labels derived from the first hashed ID list; transmitting, by a second encrypted label transmission module of the second-party processing module, one or more encrypted identifiers or partial encrypted labels derived from the second hashed ID list; receiving, by a computation module of a third-party processing module, the encrypted identifiers or the partial encrypted labels from both the first encrypted label transmission module and the second encrypted label transmission module; computing, by the computation module, a matching result indicating whether the encrypted identifiers from the first and second hashed ID lists correspond to a match; generating, based on the matching result, a matching table comprising real and dummy matches; regrouping, by a subset regrouping module of the third-party processing module, the matching table into subsets, wherein the subsets are selectively distributed to the first-party processing module and the second-party processing module to prevent reconstruction of full intersection; and, outputting, by a result delivery module of the third-party processing module, a pseudo set intersection alignment result based on the subsets to be distributed, to the first-party processing module and the second-party processing module for use in subsequent privacy-preserving computations.

By the configuration, the aim of the present invention is to ensure that two or more parties with confidential set intersection overlapping labels will not be revealed; non-overlapping labels will not be revealed; and insiders or individuals within any party cannot recover the hash with the available information.

### BRIEF DESCRIPTION OF DRAWINGS

Embodiments of the invention are described in more details hereinafter with reference to the drawings, in which:

FIG. 1 illustrates an architecture of a system for privacy-preserving confidential set intersection according to some embodiments of the present invention;

FIG. 2 is a schematic diagram illustrating a method for set intersection without revealing overlapping or non-overlapping labels using the system of FIG. 1 according to some embodiments of the present invention;

FIG. 3 illustrates a schematic flow sequence of the method shown in FIG. 2 according to some embodiments of the present invention;

FIG. 4 illustrates an architecture of a system for privacy-preserving confidential set intersection according to some embodiments of the present invention;

FIG. 5 is a schematic diagram illustrating a method for set intersection without revealing the hash using the system of FIG. 4 according to some embodiments of the present invention;

FIG. 6 illustrates a schematic flow sequence of the method shown in FIG. 5 according to some embodiments of the present invention; and

FIG. 7 illustrates a method for privacy-preserving batch operations according to some embodiments of the present invention.

### DETAILED DESCRIPTION OF THE INVENTION

In the following description, systems and methods for privacy-preserving confidential set intersection and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

Confidential set intersection presents an issue in multi-party data collaboration, as it requires computing the intersection of unique label sets while ensuring data privacy. Two major concerns are to be addressed: (1) the potential exposure of overlapping labels; and (2) the risk of insiders obtaining hashed labels. In the present invention, a system and method are provided to enhance label protection in scenarios where two parties need to determine the intersection of their label sets, such as identity matching in vertical federated learning.

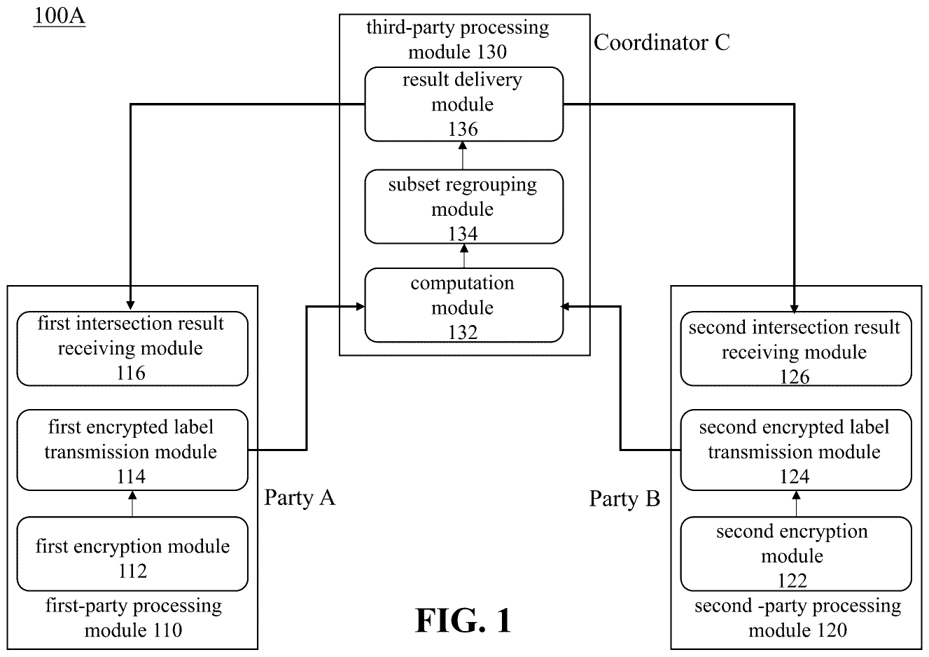

Referring to FIG. 1 for the following description. A system 100A for privacy-preserving confidential set intersection is provided and includes a first-party processing module 110, a second-party processing module 120, and a third-party processing module 130.

In the system 100A, the first-party processing module 110 and the second-party processing module 120 represent two independent entities that each hold a unique set of encrypted labels and seek to compute their intersection without revealing sensitive information; for example, Party A and Party B. The two entities may include, for example, financial institutions performing identity matching for fraud detection, healthcare organizations comparing patient records for collaborative research, or advertising platforms identifying overlapping user segments for targeted marketing. The third-party processing module 130 serves as a trusted coordinator responsible for receiving encrypted labels from both parties, performing secure computations to determine potential matches, and returning obfuscated results that prevent either party from directly inferring the full intersection; for example, Coordinator C.

Each of the first-party processing module 110, the second-party processing module 120, and the third-party processing module 130 is equipped with a user interface, enabling users to interact with the system 100A, monitor progress, and manage operations in real time.

The first-party processing module 110 includes a first encryption module 112, a first encrypted label transmission module 114, and a first intersection result receiving module 116. The first encryption module 112 is configured to encrypt and hash data of the Party A to generate one or more encrypted labels (e.g., (H(id(A))). The first encrypted label transmission module 114 is configured to securely transmit the encrypted labels to the third-party processing module 130 of the Coordinator C. The first intersection result receiving module 116 is configured to receive the matching results from the third-party processing module 130 of the Coordinator C for further processing.

The second-party processing module 120 includes a second encryption module 122, a second encrypted label transmission module 124, and a second intersection result receiving module 126. The second encryption module 122 is configured to encrypt and hash data of the Party B to generate one or more encrypted labels (e.g., (H(id(B))). The second encrypted label transmission module 124 is configured to securely transmit the encrypted labels to the third-party processing module 130 of the Coordinator C. The second intersection result receiving module 126 is configured to receive the matching results from the third-party processing module 130 of the Coordinator C.

In one embodiment, the first encryption module 112 and second encryption module 122 are configured to facilitate an agreement on a common encryption technique between the first-party processing module 110 of Party A and the second-party processing module 120 of Party B, allowing consistent data encryption and hashing for secure processing.

The third-party processing module 130 includes a computation module 132, a subset regrouping module 134, and a result delivery module 136.

The computation module 132 is configured to compute the distance between the encrypted labels of Party A and Party B (i.e., H(id(A)) and H(id(B))) to determine whether each hashed ID of the encrypted labels corresponds to a real match or a dummy match. The computation by the computation module 132 operates without exposing raw identifiers, maintaining the integrity of the matching process. The computation module 132 is further configured to generate a matching table that differentiates real matches from dummy matches for both Party A and Party B. The generation process by the computation module 132 follows a structured protocol that restricts either party from independently reconstructing the complete intersection. In this regard, the matching table, containing both real and dummy match sets, is securely maintained within the computation module 132, preventing unintended data exposure.

The subset regrouping module 134 is configured to partition the real and dummy match sets into subsets, generating partial matching results for Party A and Party B. That is, the real and dummy match sets are regrouped into the subsets for Party A and Party B respectively. In one embodiment, the partitioning by the subset regrouping module 134 applies an additional layer of obfuscation, limiting the ability of either party to derive the full set of matched entries.

The result delivery module 136 is configured to transmit the subsets to the first-party processing module 110 of Party A and the second-party processing module 120 of Party B while controlling access to the intersection results. In one embodiment, the subsets are selectively distributed into each party to prevent them from reconstructing the full intersection. The real match set remains confidential and is not directly exposed to Party A or Party B, preserving privacy and data security.

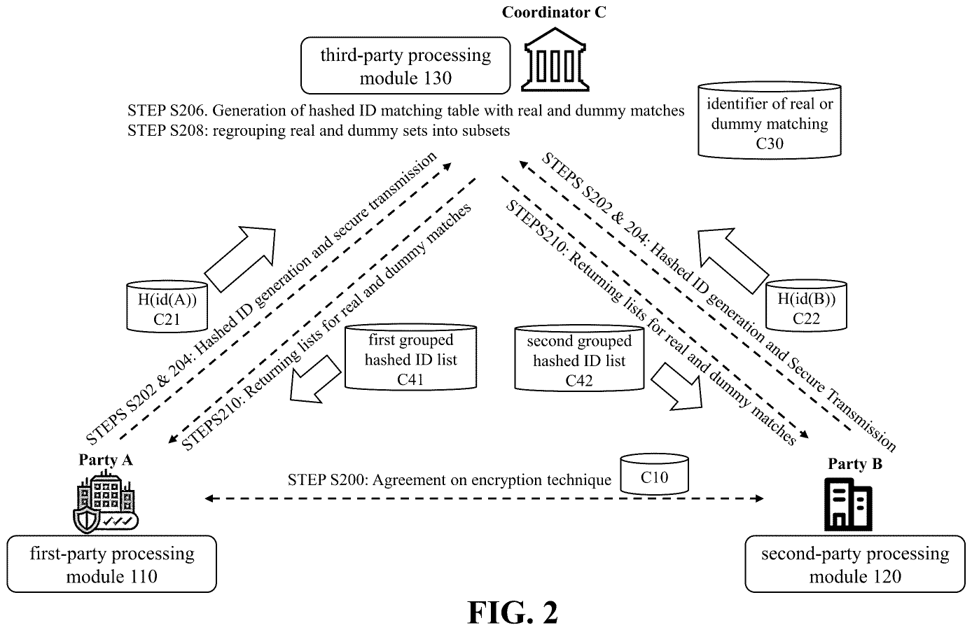

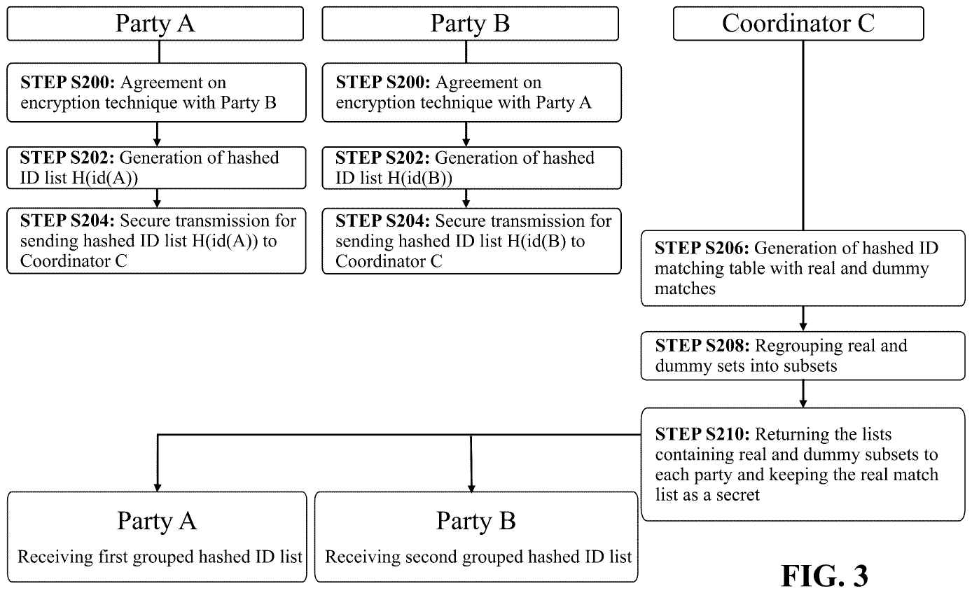

FIG. 2 is a schematic diagram illustrating a method for set intersection without revealing overlapping or non-overlapping labels using the system 100A of FIG. 1 according to some embodiments of the present invention. FIG. 3 illustrates a schematic flow sequence of the method shown in FIG. 2 according to some embodiments of the present invention. The system 100A for privacy-preserving confidential set intersection operates the first-party processing module 110 serving as a Party A, the second-party processing module 120 serving as a Party B, and the third-party processing module 130 serving as a trusted coordinator C. The process involves multiple secure steps requiring neither Party A nor Party B to independently reconstruct the full intersection while maintaining confidentiality in data exchange.

The method includes step S200, S202, S204, S206, S208, and S210.

Step S200 involves reaching an agreement on encryption technique C10. In this step, the first encryption module 112 of the first-party processing module 110 and the second encryption module 122 of the second-party processing module 120 are configured to facilitate an agreement on a common encryption technique C10 between Party A and Party B. In one embodiment, the common encryption technique C10 includes a hash function. Step S200 establishes that both parties employ the same hashing function or encryption scheme to process their respective data. In this regard, only encryption technique information (e.g., hash function) is exchanged between Party A and Party B, and no other information is shared.

Steps S202 and S204 involve hashed ID list generation and secure transmission, where each party independently hashes and encrypts its dataset. In step S202, the first encryption module 112 of the first-party processing module 110 processes Party A's dataset to generate multiple hashed identifiers (e.g., hashes of IDs for Party A), collectively forming a first hashed ID list C21, denoted as H(id(A)). Similarly, the second encryption module 122 of the second-party processing module 120 processes Party B's dataset to generate multiple hashed identifiers (e.g., hashes of IDs for Party B), collectively forming a second hashed ID list C22, denoted as H(id(B)).

In step S204, the first and second hashed ID lists H(id(A)) C21 and H(id(B)) C22 are securely transmitted via the first encrypted label transmission module 114 of the first-party processing module 110 and the second encrypted label transmission module 124 of the second-party processing module 120, respectively, to the third-party processing module 130 of Coordinator C. At this point, Party A and Party B do not exchange any hashed IDs directly; instead, Party A and Party B transmit their first and second hashed ID lists H(id(A)) C21 and H(id(B)) C22 exclusively to the computation module 132 of the third-party processing module 130, at Coordinator C, to complete the merely transmission purpose.

Step S206 involves generation of hashed ID matching table with real and dummy matches. In this step, upon receiving the first and second hashed ID lists H(id(A)) C21 and H(id(B)) C22, the computation module 132 of the third-party processing module 130 performs matching computation and dummy matching. Specifically, the computation module 132 computes the distance between the first and second hashed ID lists H(id(A)) C21 and H(id(B)) C22 (i.e., the distance between the encrypted labels of Party A and Party B) to determine whether each hashed ID corresponds to a real match or a dummy match. Thereafter, the computation module 132 of the third-party processing module 130 generates a matching table that classifies encrypted IDs of Party A and Party B into real matches and dummy matches using identifier of real or dummy matching C30. The identifier of real or dummy matching C30 includes a plurality of real and dummy sets and is kept confidential within the third-party processing module 130 under Coordinator C without being disclosed to either party.

Step S208 involves regrouping real and dummy sets into subsets. In this step, the subset regrouping module 134 of the third-party processing module 130 generates the unions of selected subsets from the real and dummy sets, in which the subsets are then shared individually with each party instead of returning a complete match list (i.e., complete real and dummy matching). In one embodiment, the generated subsets may optionally include a mixture of real and dummy matches to enhance privacy and prevent either party from inferring the complete intersection, and thus what the subset regrouping module 134 generates is a set of lists containing real and dummy subsets to be shared with Party A and Party B.

The generation process in step S208 by the subset regrouping module 134 is flexible and can be adjusted based on specific requirements; for example, whether to reveal the number of real matched labels or keep them undisclosed, and whether to return subsets for improved efficiency by reducing dummy cases or, in an extreme condition, refrain from returning subsets for maximum privacy protection. In some embodiments, the ratio of real-to-dummy matches in the subsets is adjusted, along with setting a minimum subset size to prevent extreme cases that could compromise privacy.

Step S210 involves returning lists for real and dummy matches. The result delivery module 136 of the third-party processing module 130 returns the lists, which are generated by the subset regrouping module 134 and contain the real and dummy subsets to each party (i.e., Party A and Party B) while keeping the real match list confidential. At Coordinator C, the result delivery module 136 filters the real matches and aggregates the gradient for the federated training process, enabling privacy-preserving machine learning applications without exposing individual records. Accordingly, the result delivery module 136 ensures that each party only receives a partial matching result and cannot reconstruct the full intersection independently.

In one embodiment, the result delivery module 136 returns a first grouped hashed ID list C41 containing a mixture of real and dummy matches to the first-party processing module 110 of Party A and a second grouped hashed ID list C42 containing a mixture of real and dummy matches to the second-party processing module 120 of Party B, achieving controlled result distribution. In one embodiment, the first grouped hashed ID list C41 is a subset of the first hashed ID list H(id(A)) C21, and the second grouped hashed ID list C42 is a subset of the second hashed ID list H(id(B)) C22. The first grouped hashed ID list C41 and the second grouped hashed ID list C42 are not necessarily identical in composition, even though both contain a mixture of real and dummy matches. The composition of each list may vary in terms of the ratio of real to dummy matches or subset structure, preventing either party from independently reconstructing the full intersection.

Then, the first-party processing module 110 at Party A receives the first grouped hashed ID list C41 via the first intersection result receiving module 116, and the second-party processing module 120 at Party B receives the second grouped hashed ID list C42 via the second intersection result receiving module 126. In this regard, the process does not reveal overlapping or non-overlapping labels, thereby protecting confidential information.

Specifically, Party A knows which encryption technique C10 is applied and owns the first grouped hashed ID list C41 but cannot infer the overlapping encrypted ID, as it depends on the intersection between the first grouped hashed ID list C41 and the identifier of real or dummy matching C30. Similarly, Party B knows which encryption technique C10 is applied and owns the second grouped hashed ID list C42 but cannot infer the overlapping encrypted ID, due to the same intersection-based restriction. The Coordinator C has access to the first and second hashed ID lists, H(id(A)) C21 and H(id(B)) C22, as well as the identifier of real or dummy matching C30 but still cannot infer the raw ID due to the lack of knowledge of the encryption technique C10 applied.

In one embodiment, after receiving the first grouped hashed ID list C41 and the second grouped hashed ID list C42, Party A and Party B can utilize these subsets for various privacy-preserving computations across different scenarios. In federated learning, financial institutions, such as banks and credit agencies, can use the matched customer data for collaborative model training without exposing complete customer records. The subsets of the first grouped hashed ID list C41 and the second grouped hashed ID list C42 serve as matched customer indicators, allowing both parties to perform federated gradient updates based solely on the intersection results, eliminating the need to exchange raw data. For cross-marketing and advertising attribution, advertising platforms can analyze overlapping user segments through differential privacy techniques, utilizing the first grouped hashed ID list C41 and the second grouped hashed ID list C42 to compute de-duplicated user counts across platforms while maintaining individual privacy.

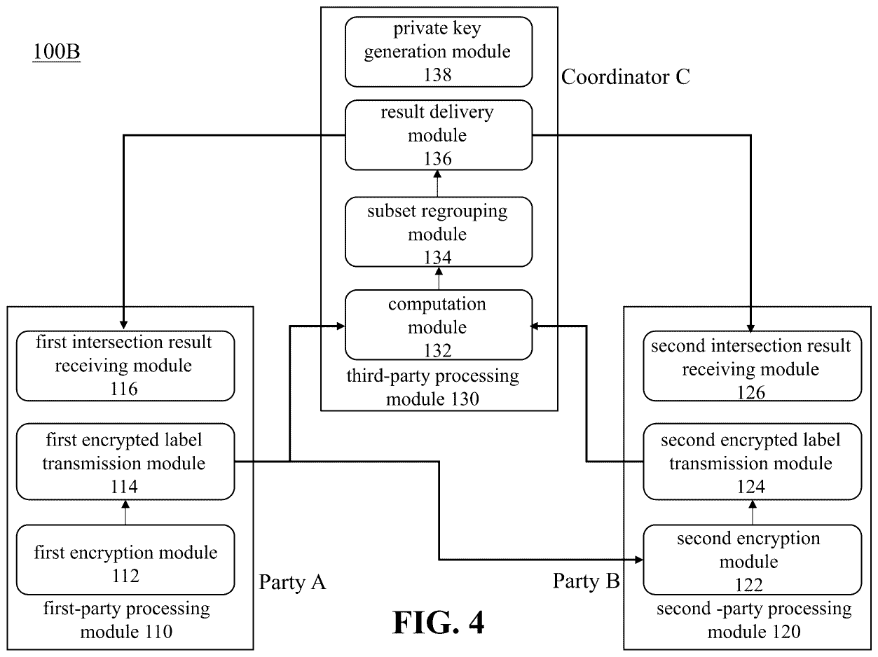

Referring to FIG. 4 for the following description. A system 100B for privacy-preserving confidential set intersection is provided. The system 100B has a configuration similar to that of system 100A; however, the system 100A aims to perform set intersection without revealing overlapping or non-overlapping labels, and the system 100B focuses on set intersection without revealing the hash, providing additional protection.

The system 100B includes a first-party processing module 110, a second-party processing module 120, and a third-party processing module 130. The configuration features of the system 100B, compared to those of the system 100A, are provided as follows.

The first encryption module 112 of the first-party processing module 110 is further configured to split and encrypt Party A's one or more encrypted labels (e.g., hash of ID) using an operable encryption technique, generating two partial encrypted labels for Party A. For example, after the first encryption module 112 encrypts and hashes Party A's data to generate one or more encrypted labels (e.g., H(id(A))), the generated encrypted labels are further split into two partial encrypted labels. Similarly, the second encryption module 120 of the second-party processing module 122 is further configured to split and encrypt Party B's one or more encrypted label (e.g., hash of ID) using an operable encryption technique, generating two partial encrypted labels for Party B. For example, after the second encryption module 122 encrypts and hashes Party B's data to generate one or more encrypted labels (e.g., H(id(B))), the generated encrypted labels are further split into two partial encrypted labels.

For clarity, the two partial encrypted labels generated by the first-party processing module 110 at Party A are labeled as a first Party A partial encrypted label and a second Party A partial encrypted label. Similarly, the two partial encrypted labels generated by the second-party processing module 120 at Party B are labeled as a first Party B partial encrypted label and a second Party B partial encrypted label.

The first encrypted label transmission module 114 of the first-party processing module 110 is configured to transmit the first Party A partial encrypted label to the computation module 132 of the third-party processing module 130 at Coordinator C and to transmit the second Party A partial encrypted label to the second encryption module 122 of the second-party processing module 120.

The second encryption module 122 is further configured to calculate an encrypted distance between the second Party A partial encrypted label received from Party A and the second Party B partial encrypted label generated at Party B, thereby generating encrypted distance data. The second encrypted label transmission module 124 is configured to transmit the first Party B partial encrypted label along with the encrypted distance data to the computation module 132 of the third-party processing module 130 at Coordinator C.

The third-party processing module 130 further includes a private key generation module 138, which is configured to generate a private key and public key pair and to share the public key with Party A and Party B. The public key is used for homomorphic encryption type [a], where the value of “a” is encrypted by the type of homomorphic encryption. The computation module 132 is configured to compute the match distance using the first Party A partial encrypted label, the first Party B partial encrypted label, and the encrypted distance data. The computation module 132 is further configured to decrypt the computed distance using the private key generated by the private key generation module 138. It results in an ID distance between the encrypted labels of Party A and Party B (e.g., between H(id(A)) and H(id(B))). The computation performed by the computation module 132 is subsequently processed by the subset regrouping module 134. Similar to the functions provided by the subset regrouping module 134 in the system 100A, the output of the subset regrouping module 134 in the system 100B is referred to as a matching result with mixture of real and dummy matches. Moreover, the result delivery module 136 is configured to distribute the matching result among Party A, Party B, and Coordinator C.

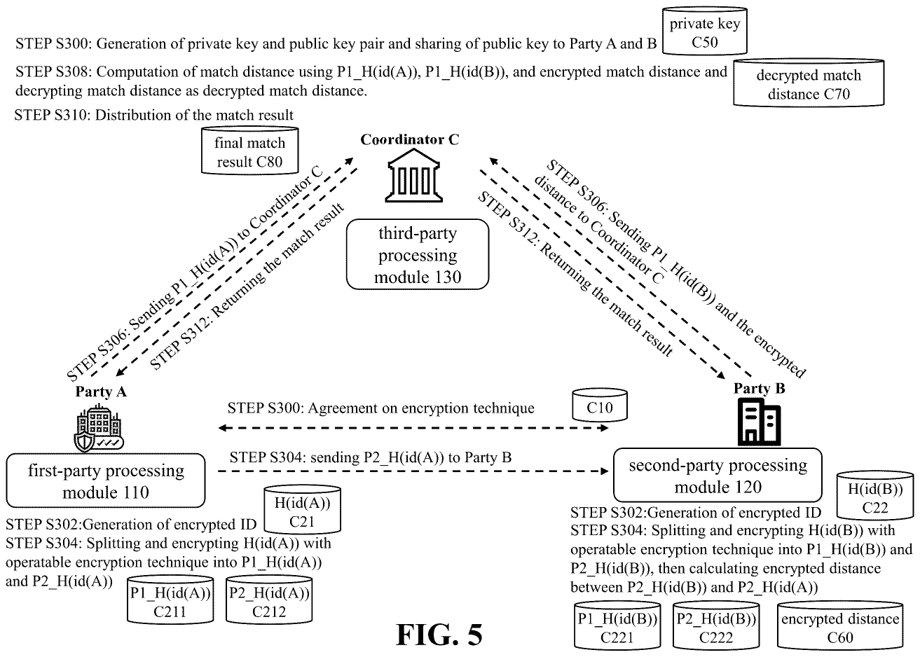

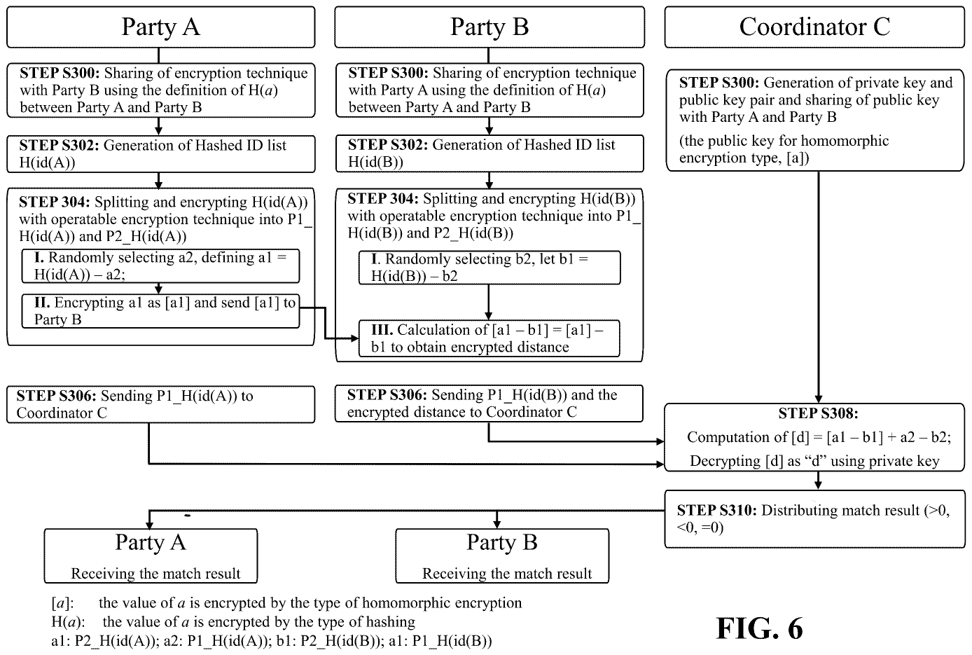

FIG. 5 is a schematic diagram illustrating a method for set intersection without revealing the hash using the system 100B of FIG. 4 according to some embodiments of the present invention. FIG. 6 illustrates a schematic flow sequence of the method shown in FIG. 5 according to some embodiments of the present invention. The system 100B for privacy-preserving confidential set intersection operates employs the first-party processing module 110 serving as a Party A the second-party processing module 120 serving as a Party B, and the third-party processing module 130 serving as a trusted coordinator C. The process involves multiple secure steps requiring neither Party A nor Party B to independently reconstruct the full intersection while maintaining confidentiality in data exchange.

The method includes step S300, S302, S304, S306, S308, S310, and S312.

Step S300 involves an agreement on the encryption technique C10, where the first encryption module 112 of the first-party processing module 110 and the second encryption module 122 of the second-party processing module 120 facilitate the establishment of a common encryption technique C10 between Party A and Party B. In one embodiment, the common encryption technique C10 includes a hash function, so that both parties use the same H(⋅) function or encryption scheme to process their respective data. Specifically, H(a) represents a hashed value derived from a using the agreed-upon hashing function, where H(a)=Hash(a). The hashing function is deterministic, meaning that if both parties input the same “a,” they obtain the same H(a), allowing for secure computations without exposing raw data. Only encryption technique information (e.g., hash function) is exchanged between Party A and Party B, and no other information is shared, reinforcing the confidentiality of the process. That is, although confidential information of the encryption technique C10 may be shared between Party A and Party B, no hash ID can be derived or speculated from the confidential information, preserving the non-reversibility and integrity of the encrypted data.

Also, in Step S300, the private key generation module 138 of the third-party processing module 130 is further configured to generate a private key C50 and corresponding public key pair. The generated public key is then shared with Party A and Party B for use in secure computations. Specifically, the public key is designated for homomorphic encryption type [a], where the value of “a” is encrypted by the type of homomorphic encryption. By distributing the public key while keeping the private key C50 confidential, the third-party processing module 130 at Coordinator C enables secure encrypted computations without exposing raw data, thereby preserving privacy throughout the intersection process.

Step S302 involves hashed ID list generation, where each party independently hashes its dataset. In step S302, the first encryption module 112 of the first-party processing module 110 processes Party A's dataset to generate multiple hashed identifiers (e.g., hashes of IDs for Party A), collectively forming a first hashed ID list C21, denoted as H(id(A)). Similarly, the second encryption module 122 of the second-party processing module 120 processes Party B's dataset to generate multiple hashed identifiers (e.g., hashes of IDs for Party B), collectively forming a second hashed ID list C22, denoted as H(id(B)).

Step S304 involves splitting and encrypting encrypted labels with operatable encryption technique into partial encrypted labels. In this step, there are phases (I), (II), and (III), as detailly shown in FIG. 6.

In the phase (I), the first encryption module 112 randomly selects a2, labelled as the first Party A partial encrypted label P1_H(id(A)) C211 and defines a1=H(id(A))−a2, where a1 is labelled as the second Party A partial encrypted label P2_H(id(A)) C212; and the second encryption module 122 randomly selects b2, labelled as the first Party B partial encrypted label P1_H(id(B)) C221 and defines b1=H(id(B))−b2, where b1 is labelled as the second Party B partial encrypted label P2_H(id(B)) C222.

In the phase (II), the first encryption module 112 of the first-party processing module 110 encrypts a1, the second Party A partial encrypted label P2_H(id(A)) C212, as [a1] and sends [a1] to the second-party processing module 120 of Party B.

In the phase (III), the second encryption module 122 calculates/computes an encrypted distance between the second Party B partial encrypted label P2_H(id(B)) C222 and the second Party A partial encrypted label P2_H(id(A)) C212. This calculation is represented as [a1−b1]=[a1]−b1, where the result is denoted as the encrypted match distance C60.

Step S306 involves transmission to the third-party processing module 130 at Coordinator C. The first Party A partial encrypted label P1_H(id(A)) C211 is securely transmitted via the first encrypted label transmission module 114 of the first-party processing module 110 to the computation module 132 of the third-party processing module 130 of Coordinator C. The first Party B partial encrypted label P1_H(id(B)) C221 and the encrypted match distance C60 are securely transmitted via the second encrypted label transmission module 124 of the second-party processing module 120 to the computation module 132 of the third-party processing module 130 of Coordinator C.

Step S308 involves computation of match distance. The computation module 132 calculates/computes a match distance using the first Party A partial encrypted label P1_H(id(A)) C211, the first Party B partial encrypted label P1_H(id(B)) C221, and the encrypted match distance C60. The match distance C60 then is decrypted by the computation module 132 using the private key C50, denoted as a decrypted match distance C70.

Specifically, this computation is executed using confidential information, including the first Party A partial encrypted label P1_H(id(A)) C211, the first Party B partial encrypted label P1_H(id(B)) C221, and the encrypted match distance C60 which are shared with Coordinator C from Party A and Party B. The Coordinator C is able to decrypt the expression [a1−b1] using the private key C50, which underlies the computation of the encrypted match distance C60, and further computes the distance between the first hashed ID list H(id(A)) C21 and the second hashed ID list H(id(B)) C22 using the provided partial labels. In this regard, without access to the second Party A partial encrypted label P2_H(id(A)) C212 and the second Party B partial encrypted label P2_H(id(B)) C222, the Coordinator C cannot reconstruct or speculate the original hashed IDs H(id(A)) or H(id(B)) based solely on the decrypted match distance C70. The calculated decrypted match distance C70 is retained solely within the third-party processing module 130 at Coordinator C and is not disclosed, maintaining the confidentiality of the underlying identifiers.

Step S310 involves distribution of the matching result. The computation module 132 of the third-party processing module 130 processes the decrypted match distance C70 to generate a final matching result C80, which indicates whether the comparison between the encrypted labels results in a positive match (>0), a negative match (<0), or an exact match (=0).

Then, in Step S312, the result delivery module 136 of the third-party processing module 130 distributes the matching result C80 to the first-party processing module 110 of Party A and the second-party processing module 120 of Party B. In one embodiment, the matching result C80 includes a mixture of real and dummy matches, preventing either party from inferring the exact intersection. The mixture of real and dummy matches is produced through the use of the subset regrouping module 134 to generate obfuscated matching results. The controlled distribution of the matching result C80 preserves confidentiality by limiting the ability of either party to reconstruct the full set of matched identifiers. Moreover, the final matching result C80 represents a form of pseudo set intersection alignment, where relative matching outcomes are revealed without explicitly exposing the actual intersecting elements. This approach enables privacy-preserving alignment by mixing real and dummy matches, preventing direct reconstruction of the true intersection.

The mechanism of the provided solution is to further prevent all participating parties, including internal actors, from reconstructing any original confidential or sensitive information. Although the final matching result C80 is shared among Party A, Party B, and Coordinator C, it does not expose hashed identifiers or raw data. Even when combining all owned transmitted information (including the encryption technique C10, the first Party A partial encrypted label P1_H(id(A)) C211, the second Party A partial encrypted label P2_H(id(A)) C212, and the first Party B partial encrypted label P2_H(id(B)) C221, the encrypted match distance C60, and the matching result C80), no party can recover the original hashed IDs H(id(A)) or H(id(B)).

For example, an insider at Party A, having access to encryption technique C10, the first hashed ID list H(id(A)) C21, and the matching result C80, cannot reconstruct the second hashed ID list H(id(B)) C22. Likewise, an insider at Party B, with access to encryption technique C10, the second Party A partial encrypted label P2_H(id(A)) C212, the second hashed ID list H(id(B)) C22, and the matching result C80, is unable to reconstruct the first hashed ID list H(id(A)). Furthermore, an insider at Coordinator C, even with access to the private key C50, the first Party A partial encrypted label P1_H(id(A)) C211, the first Party B partial encrypted label P1_H(id(B)) C221, the encrypted match distance C60, and the decrypted match distance C70, cannot infer the hashed ID list H(id(A)) or H(id(B)). Without access to either complete hashed ID list, Coordinator C cannot recover the raw identifiers. This layered structure effectively safeguards the confidentiality of all sensitive data throughout the entire process.

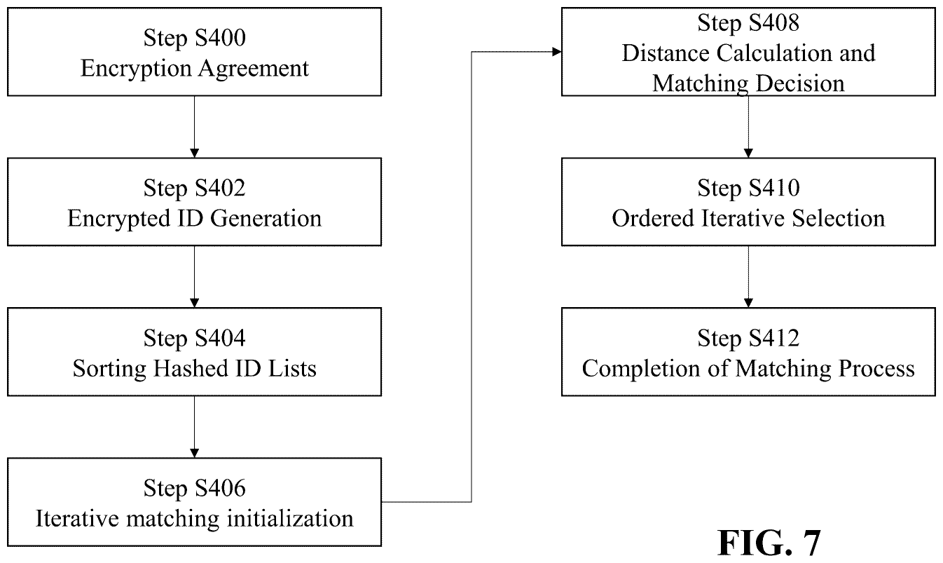

FIG. 7 illustrates a method for privacy-preserving batch operations according to some embodiments of the present invention. This method builds upon the approach described in FIG. 5 by introducing a batch operation mechanism to enhance efficiency in performing set intersection. The configuration of the system 100B is further adapted to execute the method of FIG. 7, where Party A has a first hashed ID list of length N1, and Party B has a second hashed ID list of length N2. In this extended approach, the method enables secure set intersection without exposing overlapping or non-overlapping labels by implementing an iterative matching process based on ordered encrypted identifiers, allowing batch processing of multiple hashed IDs in a structured and privacy-preserving manner.

The method includes Steps S400, S402, S404, S406, S408, S410, and S412.

In Step S400, Party A and Party B establish a common encryption technique (e.g., encryption technique C10). The first encryption module 112 of the first-party processing module 110 and the second encryption module 122 of the second-party processing module 120 facilitate an agreement on the encryption technique, such as a hash function. This step establishes that both parties use a deterministic hashing function to process their respective datasets without sharing raw data.

In Step S402, the first encryption module 112 and the second encryption module 122 generate encrypted identifiers based on their respective datasets. Specifically, Party A processes its dataset to generate a first hashed ID list H(id(A)), and Party B processes its dataset to generate a second hashed ID list H(id(B)). The resulting encrypted identifiers are unique to each dataset and do not expose any raw information.

In Step S404, both Party A and Party B sort their hashed ID lists in ascending order. The sorting step enables an ordered comparison process, in which the smallest available encrypted identifier from each party is selected for comparison.

In Step S406, an iterative matching process begins. Party A and Party B select the current hashed IDs from their respective sorted hashed lists using the first encryption module 112 and the second encryption module 122. The selected hashed IDs are then processed according to the steps as mentioned in FIG. 5 and FIG. 6 to provide data/information to the computation module 132 of the third-party processing module 130 at Coordinator C.

In Step S408, the computation module 132 calculates the encrypted distance between the selected hashed IDs and determines a matching result (e.g., the final matching result C80), which indicates whether the hashed values correspond to a positive match (>0), a negative match (<0), or an exact match (=0).

In Step S410, based on the matching result, an iterative selection process is executed by the computation module 132 of the third-party processing module 130. There are three results to be computed: If the matching result is greater than zero (>0), Party B advances to the next hashed ID in its list; If the matching result is less than zero (<0), Party A advances to the next hashed ID in its list; and if the matching result is equal to zero (=0), both parties advance to the next hashed ID in their lists. The iterative process continues until either Party A or Party B reaches the end of its hashed ID list. At most, the loop will execute N1+N2 times, ensuring that all potential matches are evaluated.

In step S412, the final matching results, distributed by the result delivery module 136 of the third-party processing module 130, provide a privacy-preserving pseudo set intersection alignment that prevents direct reconstruction of the original dataset while allowing parties to perform downstream computations based on the encrypted matching results.

The present invention is applicable to scenarios where multiple entities seek to perform privacy-preserving set intersection in a federated learning platform. For example, Company A, acting as the label owner, and Company B, serving as the data owner, aim to identify their shared data records confidentially. Both companies register on the same coordinator group within the federated learning platform, where they upload at least one dataset from their respective local sources and grant mutual access permissions. Through the proposed method, Company A and Company B can securely compute the set intersection without exposing their raw data, allowing them to create an aggregated dataset. The aggregated dataset can then be utilized for subsequent vertical federated learning training and prediction while maintaining data privacy.

The functional units and modules of the apparatuses and methods in accordance with the embodiments disclosed herein may be implemented using computing devices, computer processors, or electronic circuitries including but not limited to application specific integrated circuits (ASIC), field programmable gate arrays (FPGA), graphic processing units (GPU), microcontrollers, and other programmable logic devices configured or programmed according to the teachings of the present disclosure. Computer instructions or software codes executing in the computing devices, computer processors, or programmable logic devices can readily be prepared by practitioners skilled in the software or electronic art based on the teachings of the present disclosure.

All or portions of the methods in accordance with the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can be included, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A system for privacy-preserving confidential set intersection, comprising:
a first-party processing module comprising a first encryption module and a first encrypted label transmission module;
a second-party processing module comprising a second encryption module and a second encrypted label transmission module, wherein the first encryption module is configured to encrypt and hash a first set of identifiers into a first hashed ID list using an encryption technique agreed with the second-party processing module, and the first encrypted label transmission module is configured to transmit one or more encrypted identifiers or partial encrypted labels derived from the first hashed ID list, and wherein the second encryption module is configured to encrypt and hash a second set of identifiers into a second hashed ID list using the encryption technique, and the second encrypted label transmission module is configured to transmit one or more encrypted identifiers or partial encrypted labels derived from the second hashed ID list; and
a third-party processing module comprising:
a computation module configured to receive the encrypted identifiers or the partial encrypted labels from both the first encrypted label transmission module of the first-party processing module and the second encrypted label transmission module of the second-party processing module and to compute a matching result indicating whether the encrypted identifiers from the first and second hashed ID lists correspond to a match, thereby generating a matching table comprising real and dummy matches;
a subset regrouping module configured to regroup the matching table into subsets, which are selectively distributed to the first-party processing module and the second-party processing module, in order to prevent reconstruction of full intersection; and
a result delivery module configured to output a pseudo set intersection alignment result, based on the subsets to be distributed, to the first-party processing module and the second-party processing module for use in subsequent privacy-preserving computations.

2. The system of claim 1, wherein the subset regrouping module is further configured to generate dummy match entries alongside real matches in the matching table, thereby obfuscating true intersection and preventing either the first-party processing module or the second-party processing module from inferring a complete match set.

3. The system of claim 2, wherein the result delivery module is further configured to transmit to each of the first-party processing module and the second-party processing module only a partial subset of the matching result, such that each of the first-party processing module and the second-party processing module receives a grouped hashed ID list comprising a mixture of the real and dummy matches.

4. The system of claim 3, wherein the matching table generated by the third-party processing module is kept confidential and is not transmitted in full to either the first-party processing module or the second-party processing module.

5. The system of claim 1, wherein the first encryption module of the first-party processing module is further configured to split each encrypted identifier into a first partial encrypted label and a second partial encrypted label, and wherein the first partial encrypted label is transmitted to the third-party processing module and the second partial encrypted label is transmitted to the second-party processing module.

6. The system of claim 5, wherein the second encryption module of the second-party processing module is further configured to split each encrypted identifier into a third partial encrypted label and a fourth partial encrypted label, and wherein the third partial encrypted label is transmitted to the third-party processing module and the fourth partial encrypted label is retained within the second-party processing module.

7. The system of claim 6, wherein the second encryption module is further configured to compute an encrypted distance based on the second partial encrypted label received from the first-party processing module and the fourth partial encrypted label generated by the second-party processing module.

8. The system of claim 7, wherein the third-party processing module further comprises:
a private key generation module configured to generate a private key and public key pair for use in homomorphic encryption operations, wherein the computation module is further configured to compute a match distance from the first and third partial encrypted labels and the encrypted distance and to decrypt the match distance using the private key, thereby producing a final matching result without access to complete encryption inputs.

9. The system of claim 1, wherein the first-party processing module and the second-party processing module are further configured to sort their respective hashed ID lists in ascending order prior to transmission.

10. The system of claim 9, wherein the matching result is generated iteratively by comparing the current encrypted identifiers selected from the sorted hashed ID lists of each of the first-party processing module and the second-party processing module and by updating a selection based on whether an iterative result indicates a positive, negative, or exact match, thereby achieving a batch comparison loop, which is terminated when each of the first-party processing module and the second-party processing module reaches an end of its hashed ID list and is limited to at most N1+N2 iterations, where N1 and N2 are respective sizes of the hashed ID lists of the first-party processing module and the second-party processing module.

11. A method for privacy-preserving confidential set intersection, comprising:
encrypting and hashing, by a first encryption module of a first-party processing module, a first set of identifiers into a first hashed ID list using an encryption technique agreed upon with a second-party processing module;
encrypting and hashing, by a second encryption module of the second-party processing module, a second set of identifiers into a second hashed ID list using the encryption technique;
transmitting, by a first encrypted label transmission module of the first-party processing module, one or more encrypted identifiers or partial encrypted labels derived from the first hashed ID list;
transmitting, by a second encrypted label transmission module of the second-party processing module, one or more encrypted identifiers or partial encrypted labels derived from the second hashed ID list;
receiving, by a computation module of a third-party processing module, the encrypted identifiers or the partial encrypted labels from both the first encrypted label transmission module and the second encrypted label transmission module;
computing, by the computation module, a matching result indicating whether the encrypted identifiers from the first and second hashed ID lists correspond to a match;
generating, based on the matching result, a matching table comprising real and dummy matches;
regrouping, by a subset regrouping module of the third-party processing module, the matching table into subsets, wherein the subsets are selectively distributed to the first-party processing module and the second-party processing module to prevent reconstruction of full intersection; and
outputting, by a result delivery module of the third-party processing module, a pseudo set intersection alignment result based on the subsets to be distributed, to the first-party processing module and the second-party processing module for use in subsequent privacy-preserving computations.

12. The method of claim 11, further comprising:
Generating, by the subset regrouping module, dummy match entries alongside real matches in the matching table, thereby obfuscating the true intersection and preventing either the first-party processing module or the second-party processing module from inferring a complete match set.

13. The method of claim 12, further comprising:
transmitting, by the result delivery module, to each of the first-party processing module and the second-party processing module only a partial subset of the matching result, such that each of the first-party processing module and the second-party processing module receives a grouped hashed ID list comprising a mixture of the real and dummy matches.

14. The method of claim 13, wherein the matching table generated by the third-party processing module is kept confidential and is not transmitted in full to either the first-party processing module or the second-party processing module.

15. The method of claim 11, further comprising:
splitting, by the first-party processing module, each encrypted identifier into a first partial encrypted label and a second partial encrypted label, wherein the first partial encrypted label is transmitted to the third-party processing module and the second partial encrypted label is transmitted to the second-party processing module.

16. The method of claim 15, further comprising:
splitting, by the second-party processing module, each encrypted identifier into a third partial encrypted label and a fourth partial encrypted label, wherein the third partial encrypted label is transmitted to the third-party processing module and the fourth partial encrypted label is retained within the second-party processing module.

17. The method of claim 16, further comprising:
computing, by the second-party processing module, an encrypted distance based on the second partial encrypted label received from the first-party processing module and the fourth partial encrypted label generated by the second-party processing module.

18. The method of claim 17, further comprising:
generating, by the third-party processing module, a private key and public key pair for use in homomorphic encryption operations; and
computing, by the computation module, a match distance from the first and third partial encrypted labels and the encrypted distance, and decrypting the match distance using the private key to produce a final matching result without access to complete encryption inputs.

19. The method of claim 11, further comprising:
sorting, by each of the first-party processing module and the second-party processing module, respective hashed ID lists of the first-party processing module and the second-party processing module in ascending order prior to transmission.

20. The method of claim 19, wherein the matching result is generated iteratively by comparing the current encrypted identifiers selected from the sorted hashed ID lists of each of the first-party processing module and the second-party processing module and by updating a selection based on whether an iterative result indicates a positive, negative, or exact match, thereby achieving a batch comparison loop, which is terminated when each of the first-party processing module and the second-party processing module reaches an end of its hashed ID list and is limited to at most N1+N2 iterations, where N1 and N2 are respective sizes of the hashed ID lists of the first-party processing module and the second-party processing module.
